(19) United States
(12) Patent Application Publication
(10) Pub. No.: US 2026/0217610 A1
(43) Pub. Date: Jul. 30, 2026

(54) PREFORM FOR DIRECTED-FLOW CVI DENSIFICATION

(71) Applicant: SAFRAN CERAMICS, LE HAILLAN (FR)

(72) Inventor: Stéphane Roger André GOUJARD, MOISSY-CRAMAYEL (FR)

(21) Appl. No.: 19/151,907

(22) PCT Filed: Jan. 23, 2024
(86) PCT No.: PCT/FR2024/050086

§ 371 Date: Jul. 29, 2025

(30) Foreign Application Priority Data
Feb. 3, 2023 (FR) FR2301027

(51) Int. Cl. C04B 35/83; C04B 111/00; F16D 69/02

(52) U.S. Cl. CPC C04B 35/83; F16D 69/023; C04B 2111/00362; C04B 2235/5252; C04B 2235/612; C04B 2235/614; C04B 2235/945; C04B 2237/385; C04B 2237/64

(57) ABSTRACT

A process for manufacturing an annular fibrous preform extending between an inner edge and an outer edge, the preform including at least one through-groove on at least one face, the process including hardening the annular fibrous preform; then carving at least one through-groove on at least one face of the hardened preform.

### TECHNICAL FIELD

The invention relates to the field of preforms for the manufacture of composite materials, and more particularly those densified by directed-flow chemical vapour infiltration processes.

### PRIOR ART

Thermostructural composite materials are characterized by their high mechanical properties and their ability to maintain these properties at high temperatures. Typical examples of such thermostructural composite materials are carbon/carbon composites comprising a porous substrate densified with a carbon matrix and ceramic matrix composites comprising a porous substrate densified with a ceramic matrix.

Densification processes using chemical vapour infiltration are well known. One or more porous substrates are placed inside a chamber. A gaseous phase comprising one or more precursors of the matrix material is introduced into the chamber. The temperature and pressure conditions are adjusted to allow the gaseous phase to diffuse in the porosity of the substrates in order to deposit the matrix-forming material by decomposition of a constituent of the gaseous phase or by reaction between a plurality of constituents.

Densification processes for porous substrates require high temperatures to be reached and, in order to increase the productivity of the process, it is often considered to densify a number of porous substrates in the same densification chamber. In the case of annular porous substrates, it is generally considered to introduce these into the densification chambers in the form of stacks, the substrates having all their central passages aligned vertically and each of the substrates being separated from adjacent substrates by spacers.

In a well-known manner, the spacers can be made of Inconel or a composite material and they ensure that the reactive gaseous phase circulates in the substrates under the desired pressure conditions and ensure that the substrates are not in contact with one another.

However, the spacers placed between each of the preforms represent a significant loss of space in the densification furnace.

The highly advantageous thermomechanical characteristics of composite parts are sufficient to make them competitive, despite an expensive and complex manufacturing process, but improvements are still sought in the manufacturing processes for such parts.

### DISCLOSURE OF THE INVENTION

The invention specifically aims to improve existing directed-flow chemical vapour infiltration processes, and proposes new preforms that avoid the use of spacers, thereby saving space in the densification furnace.

According to a first of its aspects, the invention relates to an annular fibrous preform extending between an inner edge and an outer edge, characterized in that it comprises at least one through-groove on at least one face.

For the purposes of the invention, a through-groove is defined as a groove cut into the face of the preform and extending from its inner edge to its outer edge.

Because of the presence of at least one through-groove, when one annular preform according to the invention is stacked with another annular preform, whether according to the invention or not, the internal space of the stack and the external space remain in fluid communication.

The presence of the groove enables the preforms to be used in stacks in conventional furnaces for directed-flow chemical vapour infiltration processes, without the need for spacers.

More specifically, in directed-flow chemical vapour infiltration processes, openings are usually made in the spacers between the internal space of the stack of preforms and the external space.

Such openings can ensure a controlled pressure difference between the external and internal spaces of the fibrous preforms.

It is to the merit of the inventors that they envisaged that the presence of grooves directly on the fibrous preforms would nevertheless enable parts to be obtained having identical thermomechanical characteristics and shape to those of the processes of the prior art, while doing away with the need for spacers.

Moreover, conventionally, the outer faces of the preforms are machined after the chemical vapour infiltration process, as these faces have been in contact with the gaseous phase and do not have exactly the same properties as the core of the preforms.

In addition, the dimensions of the densified parts must be precisely adapted to their final applications, for example their arrangement in a heat sink in the case where they are used as a friction member, for example for a brake disc.

Thus, and in particular in an embodiment where the grooves have dimensions smaller than the thickness of material removed by the final machining, the preforms of the invention enable composite material parts to be obtained which are identical in every respect to those of the processes of the prior art, but using a simplified process.

In one embodiment, the one or more through-grooves are straight grooves, i.e. the width of the groove is constant along the entire length of the groove, from the inner edge to the outer edge. The recess created by a through-groove on the face of the fibrous preform may, for example, be rectangular in shape.

In one embodiment, the preform comprises a plurality of through-grooves on at least one of its faces.

For example, the preform may comprise a plurality of through-grooves angularly distributed over the entire face of the fibrous preform.

Through-grooves are said to be “angularly distributed” if the angle formed by the directions of two adjacent grooves is identical for all the grooves present on the face of the fibrous preform.

In one embodiment, at least one through-groove is present on each face of the fibrous preform.

In the case where grooves are present on a plurality of faces, they may be identical or different.

In one embodiment, the one or more through-grooves have a variable width between the inner edge and the outer edge. This embodiment enables the geometry of the opening to be adjusted more precisely to the desired flow of the densification gas phase passing through the through-groove.

For example, the edges of the one or more grooves may be aligned with a radial direction of the preform.

In one embodiment, the thickness of the preform varies depending on whether it is measured at a point where a through-groove is present on the surface of the preform or at a point where a groove is not present. The smallest thickness of the preform and the largest thickness of the preform can thus be defined.

In one embodiment, the smallest thickness of the preform is greater than or equal to 75% of the largest thickness of the preform.

Such an embodiment can ensure that the grooves take on the role usually assigned to spacers, while guaranteeing that they can reduce the size of the stack of preforms compared with the preforms of the prior art stacked with spacers.

In one embodiment, even at the points where the thickness of the preform is smallest, the thickness of the preform can be greater than or equal to 15 mm, or even 20 mm.

This ensures that once the final machining has been carried out, the part obtained has sufficient dimensions for application as a friction part, for example as a brake disc.

In such an embodiment, the portion without through-grooves may extend over at least 75% of the thickness of the preform.

In one embodiment, the width of the one or more through-grooves is less than or equal to 20 mm.

In the case where the one or more through-grooves have a variable width, the groove may have a width greater than or equal to 10 mm and less than or equal to 20 mm.

In one embodiment, the width of the groove may increase from the inner edge of the preform to the outer edge of the preform.

In this embodiment, the amount of material to be removed after densification is reduced, making machining easier.

In one embodiment, the width of the groove may decrease from the inner edge of the preform to the outer edge of the fibrous preform.

In one embodiment, the one or more through-grooves have a depth less than or equal to 2.5 mm.

This depth ensures that the groove has a depth less than the thickness of preform removed during final machining.

In one embodiment, the thickness of fibrous preform removed is less than or equal to 5 mm, for example is between 2.8 mm and 3.2 mm, or even equal to 3 mm.

In one embodiment, a face of the fibrous preform comprising a through-groove may further comprise a circular furrow on that face of the fibrous preform, the circular furrow being in contact with the inner edge.

When such a furrow is present, the through-grooves are therefore located between the circular furrow and the outer edge of the fibrous preforms. In other words, the through-grooves open into the furrow.

This embodiment avoids the deposition of pyrolytic carbon on the internal diameter of the preform, which can form a blister at the end of the process, as has been observed with preforms that do not have such a furrow.

In one embodiment, a face of the preform comprising a through-groove may further comprise a circular furrow on a face of the preform comprising a through-groove, the circular furrow being in contact with the outer edge.

When such a furrow is present, the through-grooves are therefore located between the circular furrow and the inner edge of the preforms.

This process makes it easier to disassemble stacks of preforms after the densification process has been carried out.

If present, the one or more circular furrows in contact with the inner and/or outer edge may be less than or equal to 2.5 mm deep and less than or equal to 5 mm wide.

As with the through-grooves, the furrows can be present on only one face or on both faces of the preform.

The inventors also found that these dimensions allowed a good circulation of the gas phase in a directed-flow chemical vapour infiltration process.

The annular fibrous preform can preferably be a preform comprising silicon carbide SiC fibres or carbon fibres.

In one embodiment, the fibrous preform is a friction part preform, for example an aircraft brake disc preform.

In one embodiment, the fibrous preform is a preform for a friction part, for example an aircraft brake disc, and the one or more surfaces comprising grooves are intended to form the one or more outer faces of said friction part.

In other words, at least the face of the preform that initially comprises grooves is intended to form an outer face of a friction part.

In one embodiment, the annular fibrous preform has an internal diameter of between 15 and 25 cm, an external diameter of between 40 and 50 cm and a thickness of between 20 and 30 mm.

According to another of its aspects, the invention relates to a process for manufacturing an annular fibrous preform extending between an inner edge and an outer edge, said preform comprising at least one through-groove on at least one face, said process comprising at least the following steps:
(a) a step of hardening the annular fibrous preform; then
(b) a step of carving at least one through-groove on at least one face of the hardened preform.

Unexpectedly, the inventors found that it was possible to simply carve the grooves on the preform provided that a first step (a) was carried out to harden the preform.

More specifically, if the carving of the preform takes place before it is densified and the preform therefore has poor mechanical strength. It is therefore not possible to carve the grooves on the face of the preform without taking special precautions due to its low mechanical strength.

However, once hardened, the preform can be precisely carved, and the fibrous nature of the preform is not sufficient to return it to its original shape.

In one embodiment, step (a) of hardening the preform can be carried out by impregnating with a hardening compound, for example polyvinyl alcohol (often referred to as PVA), polyethylene glycol (often referred to as PEG) or a mixture of these compounds.

For example, hardening step (a) can be carried out by soaking the preform in a bath comprising a hardening compound, then optionally passing it through an oven.

Alternatively, hardening step (a) can be carried out by impregnating the one or more faces of the preform to be carved with a hardening compound, for example by means of a spray.

Such an embodiment allows a smaller quantity of hardening compound to be used, which lowers the overall cost of the process.

In both of the above cases, the use of a hardening agent makes preparation of the preform relatively simple.

In particular, it is not necessary to treat the hardened carved preform to remove the hardening agent, since the temperature required for the subsequent preform densification step will be sufficient to remove the hardening compound by pyrolysis, whether it impregnates all or only part of the preform.

In one embodiment, step (a) for hardening the preform can be broken down into two sub-steps (a1) and (a2).

In one embodiment, step (a) may comprise at least the following steps:
(a1) a step of saturating the annular fibrous preform with moisture; then
(a2) a step of hardening the preform by lowering the temperature below 0° C., preferably to less than or equal to −5° C., for example equal to −5° C.

Lowering the temperature during step (a2) of the preform saturated with moisture during step (a1) allows the introduced moisture to freeze and consequently harden the preform.

This process is particularly preferred as it avoids the use of chemical compounds, making the process more environmentally friendly.

In addition, after step (b) of carving the fibrous preform, the moisture saturating the preform will require simple baking in order to have dry preforms before introducing them into the densification furnace.

In one embodiment and whatever the embodiment of step (a), step (b) can be carried out by means of a cutting object or by abrasion, for example by grinding.

Together, steps (a) and (b) enable a preform as described above to be obtained, with at least one through-groove.

According to another of its aspects, the invention also relates to a stack of a plurality of fibrous preforms each being as described above.

The advantage of this type of stack is that it can be introduced into a densification chamber without the need to position spacers between the fibrous preforms, unlike prior art processes.

In this way, it is possible to introduce more preforms into the densification chamber without reducing the quality or thickness of the parts obtained after densification.

According to another of its aspects, the invention relates to a process for manufacturing a composite material part comprising at least the following steps:
(c) densifying, by a directed-flow chemical vapour infiltration process, a stack of annular fibrous preforms, at least one of which as described above; then
(d) separating the densified preforms obtained from the directed-flow chemical vapour infiltration process; then
(e) a step of final machining of the faces of the densified fibrous preforms.

Unlike directed flow chemical vapour infiltration processes of the prior art, the process according to the invention does not require the use of spacers.

Thus, in one embodiment, the stack of annular fibrous preforms comprises annular fibrous preforms in direct contact with one another.

In one embodiment, the annular fibrous preform stack can be a preform stack as just described.

Given the usual dimensions of a stack of preforms, of a densification furnace for a chemical vapour infiltration process and of a densification spacer, the absence of spacers can represent an increase in the number of preforms impregnated during one complete densification cycle of at least 7.5%, or even between 7.5% and 15%. The absence of spacers means that the process of the invention saves a substantial amount of space in the furnace.

The one or more grooves present on the face of the fibrous preforms perform the function usually assigned to the spacers.

In one embodiment, all the preforms of the stack conform to those described above. However, such a feature is not necessary and it may be advantageous to include some of the usual annular fibrous preforms, i.e. without through-grooves, in order to optimize the pressure difference between the inside and outside of the preforms, this being a function of the dimensions and number of grooves present in the final stack.

However, due to the absence of spacers, densification by the chemical vapour infiltration process causes the preforms of a given stack to stick together.

It is to the merit of the inventors that they found that separating the preforms obtained nevertheless enabled a composite material part to be obtained using a process that was generally more efficient than the processes of the prior art.

In one embodiment, spacers, made for example of ceramic material, may be present at the top and bottom of the stack of preforms.

Such spacers enable the preforms at the ends of the stack to avoid sticking to elements of the furnace, such as the trays on which the preforms are placed, for example.

Step (d) for separating the preforms can be carried out in various ways.

In one embodiment, separation step (d) can be carried out by mechanical separation.

For example, separation step (d) can be carried out by a mechanical cutting operation, for example by means of a saw, for example a circular saw of sufficient diameter or a saw with a reciprocating blade movement.

More specifically, the mechanical cutting step enables easy separation of the preforms, and does not damage the preform over a thickness greater than that which will be removed during the final machining step (e).

In one embodiment, it is possible to carry out steps (d) and (e) using a single cutting step, but with a saw having a blade thickness corresponding to the thickness to be removed between two preforms.

Alternatively, the inventors have found that step (d) of separating the fibrous preforms can be carried out as a heat treatment step performed at a temperature greater than or equal to 1600° C., preferably greater than or equal to 2000° C.

Such a step (d) for separating the preforms is particularly preferable, insofar as high-temperature heat treatment is recommended to finalize the production of composite material parts.

High-temperature heat treatment causes the matrix formed on the faces of the fibrous preform to shrink, resulting in the separation of two successive preforms in a stack that have become attached to one another during the chemical vapour infiltration process due to the deposition of the reactive gas phase on their respective faces. If the preforms have not completely come apart, their adhesion is sufficiently reduced for separation to be achieved by applying a moderate mechanical force.

In one embodiment, separation step (d) may be a mechanical separation step followed by a heat treatment carried out at a temperature greater than or equal to 1600° C., preferably greater than or equal to 2000° C.

Finally, the process of manufacturing a composite material part includes a step (e) of machining the face of the preform.

Specifically, the presence of through-grooves is undesirable in the final part and it is therefore necessary to remove the grooves from the final part.

It should be noted, however, that this step does not introduce any additional complexity compared with prior art processes for manufacturing a composite material part.

Conventionally, the faces of composite parts are machined after they have been obtained using a chemical vapour infiltration process, because the faces of the fibrous preforms have been more exposed to the reactive gas phase during the chemical vapour infiltration process and therefore do not have the same properties as the rest of the part.

For example, step (e) enables the faces of the fibrous preform to be machined to a thickness of more than 3.0 mm, for example between 3.0 mm and 5.0 mm.

This machining step (e) removes the face of the preforms that has been in contact with the reactive gaseous phase of the chemical vapour infiltration process and thus ensures that the properties of the composite material parts obtained at the end of the process are homogeneous, by removing the part most exposed to the reactive gaseous phase. In addition, this step (e) enables the parts to be brought into conformity with the desired dimensional tolerances, so that they can be installed in the heat sinks.

In one embodiment of the process of the invention, the composite material part comprises carbon fibres and a carbon matrix.

In one embodiment of the process of the invention, the composite material part is a friction part, for example an aircraft brake disc.

The above mentioned features and advantages, and others, will become apparent on reading the detailed description which follows, of exemplary embodiments of the proposed device and process. This detailed description refers to the attached drawings.

### BRIEF DESCRIPTION OF THE DRAWINGS

FIG. 1 schematically shows a plant for carrying out a directed-flow chemical vapour infiltration process.

FIG. 2 schematically shows a fibrous preform of the invention, in one embodiment of the invention.

FIG. 3 schematically shows a fibrous preform of the invention, in one embodiment of the invention.

FIG. 4 schematically shows a stack of fibrous preforms for carrying out a process of the invention.

FIG. 5 schematically shows a fibrous preform of the invention, in one embodiment of the invention.

FIG. 6 is a flow chart showing the steps in a process for manufacturing a composite material part according to the invention.

### DESCRIPTION OF THE EMBODIMENTS

The invention is now described by means of figures, having the descriptive aim of illustrating certain embodiments of the invention and which must not be interpreted as limiting the latter.

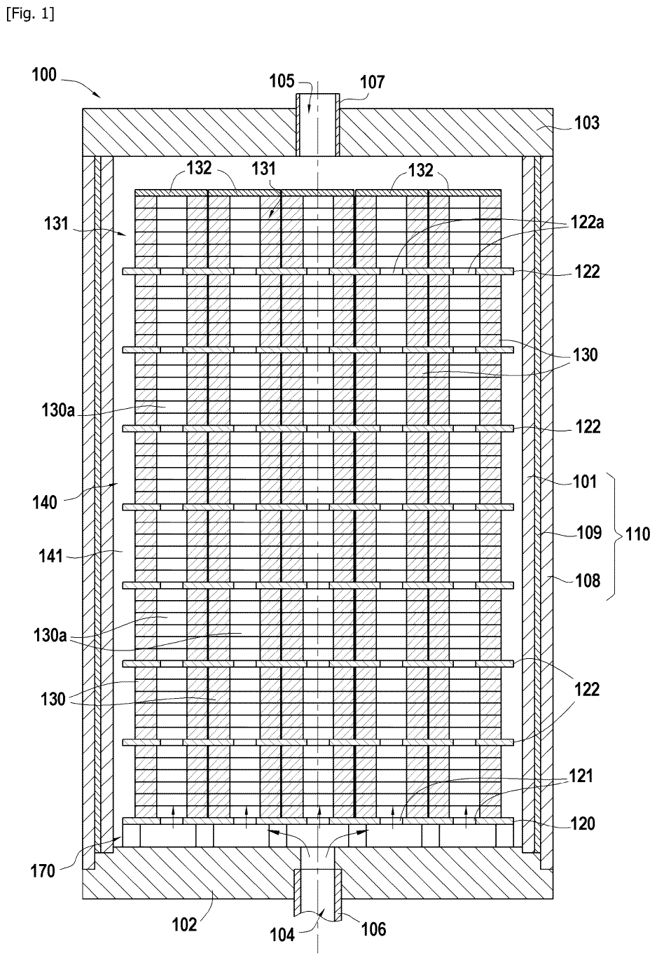

An example of a plant 100 for chemical vapour infiltration of porous preforms is described in relation to FIG. 1.

FIG. 1 shows a schematic diagram of a gaseous-phase chemical vapour infiltration densification plant 100, the loading zone 140 of which is delimited by a cylindrical side wall 101, a bottom wall 102 and a top wall 103.

Substrates to be densified 130, in this case annular fibrous preforms, can be disposed in the loading zone 140 in a plurality of annular vertical stacks 131 which rest on a loading tray 120. This comprises a plurality of passages 121 aligned with the internal volumes 130a of the stacks and each stack is closed off at the top by a cover 132.

Preferably, the stacks 131 of substrates 130 rest on the loading tray 120 and can be divided into a plurality of superimposed sections separated by one or more intermediate trays 122 having central passages 122a aligned with those of the substrates 130. FIG. 1 shows stacks 131 in which the fibrous preforms 130 are in direct contact with one another. More specifically, each stack of substrates 131 comprises at least one preform as described and comprising through-grooves, which ensures fluid communication between the internal volumes 130a and the external volume 141, and makes it possible to dispense with the spacers normally used.

The dimensions of the through-grooves of the preforms 130 of the invention can be chosen so as to substantially balance the pressure between the volumes 130a and 141.

A gaseous flow, represented by arrows, containing one or more gaseous precursors of the material constituting the matrix, is admitted into the furnace through an inlet orifice 104 delimited by a pipe 106.

The gaseous phase is then conveyed through the passages 121 from the loading tray 120 into the internal volumes 130a of the stacks 131. The gaseous phase then passes into the volume 141 outside the stacks inside the loading zone 140. The effluent gas is extracted through a passage 105 formed in the upper wall 103, the passage 105 being connected by a pipe 107 to suction means, such as a vacuum pump (not shown).

In one embodiment, the gas phase can pass through a preheating zone, for example located between the inlet orifice 104 and the loading tray 120.

In the embodiment shown, the gaseous phase simply enters a distribution zone 170, which enables a good distribution of the phase between the various internal volumes 130a of the stacks 131 of preforms 130.

In the example described here, the heating means 110 of the plant is an induction heating element. More specifically, the cylindrical side wall 101 delimiting the loading zone 140 constitutes an armature, or susceptor, for example made of graphite, which is coupled with an inductor 108 located outside the furnace and formed by at least one induction coil. An insulator 109 is interposed between the inductor 108 and the wall 101. In a well-known manner, the furnace is heated by heating the armature 101 when the inductor 108 is supplied with an AC voltage. For this purpose, the one or more inductor coils are connected to an AC voltage generator (not shown).

The magnetic field created by the inductor 108 induces an electric current in the wall 101 (susceptor) which, by the Joule effect, causes the latter to heat up, the elements present inside the wall 101 being heated by radiation.

The heating means 110 of the plant 100 can be provided by other means such as electrical heating means consisting, for example, of heating resistors embedded in the wall 101.

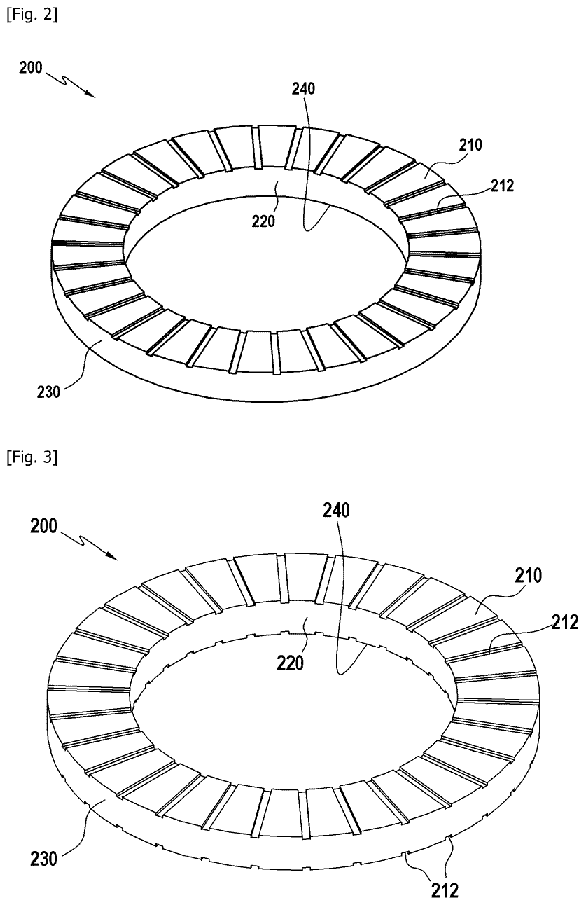

FIG. 2 shows an annular fibrous preform in a first embodiment of the invention.

The annular fibrous preform 200 comprises an inner edge 220 and an outer edge 230.

Preferably, as shown here, the preform 200 has a circular shape.

The preform also comprises two flat faces 210 and 240, referred to as the upper face 210 and the lower face 240 respectively. However, it should be understood that this nomenclature is by no means exhaustive.

In the embodiment shown in FIG. 2, the preform 200 comprises through-grooves 212 on its upper surface 210.

In this case the through-grooves 212 are straight grooves, but this does not limit the invention.

FIG. 3 shows an alternative embodiment of a preform 200 according to the invention.

In the alternative embodiment shown in FIG. 3, the preform comprises grooves 212 on both its upper surface 210 and its lower surface 240.

In this embodiment, the through-grooves 212 are identical on both sides, but this is not necessary.

As shown in FIGS. 2 and 3, the terms used should not be understood to mean that the through-groove 212 passes through the preform from the upper face 210 to the lower face 240. Specifically, and as shown, the one or more through-grooves pass through the preform 200 from the inner edge 220 to the outer edge 230.

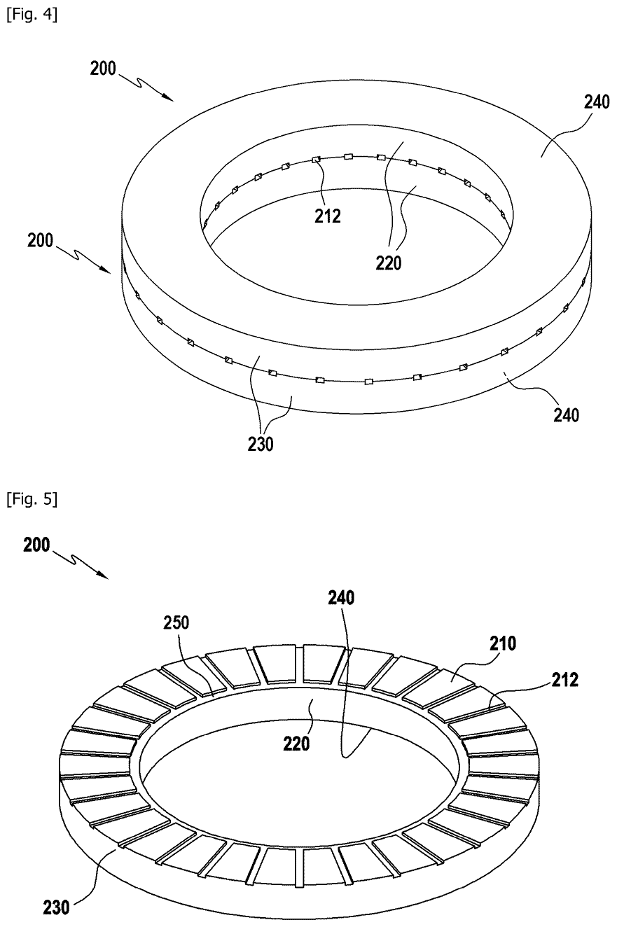

In an alternative embodiment to that shown in FIG. 4, the preforms can also be disposed so that the through-grooves do not face one another.

The two fibrous preforms correspond to preforms 200 as shown in FIG. 2, the through-grooves of which are arranged opposite one another. In other words, the two upper faces 210 of the preforms are disposed in contact with one another.

In the embodiment shown, a single channel is formed by joining the through-grooves 212 of the two preforms, enabling fluid communication between the inside of the preforms and the outside of the preforms 200.

In an alternative design to that shown in FIG. 4, two preforms 200 can also be disposed as shown, but so that the through-grooves on one side do not face the through-grooves on the other side.

FIG. 5 shows a preform in one embodiment of the invention.

The preform 200 comprises a circular furrow 250 at the inner edge 220 on the upper face 210 of the preform. The through-grooves 212 then extend between the circular furrow 250 and the outer edge 230.

The circular furrow 250 is produced on the face of the preform 200 at the same time and in the same way as the through-grooves 212.

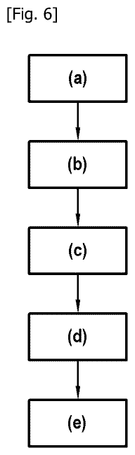

FIG. 6 shows a flowchart of the various stages in a process for manufacturing a composite material part.

The process comprises a plurality of steps numbered (a) to (e) already described above.

Step (a) is a step of hardening the fibrous preform.

This ensures that the preform has sufficient mechanical strength for it to be carved.

Step (b) is a step of carving the hardened preform.

This can advantageously be carried out by cutting with a cutting object or by abrasion, for example by grinding. More specifically, hardening of the fibrous preform enables precise cutting of the preform, which would not be possible on an unhardened fibrous preform, as the latter does not have sufficient mechanical strength.

Step (c) is a step of densifying a stack of preforms using a directed-flow chemical vapour infiltration process.

Such a process has been described in relation to FIG. 1.

For example, the process can be carried out with a reactive gas phase comprising, for example, methane, ethane, propane, butane or a mixture of these gases, the reactive gas phase optionally comprising a neutral carrier gas, for example argon.

In particular, such a reactive gaseous phase makes it possible to obtain a pyrolytic carbon matrix in annular fibrous preforms, but it is understood that a person skilled in the art knows how to choose other reactive gaseous phases in order to obtain other matrix phases.

For example, the chemical vapour infiltration process can be carried out in a chamber at a temperature of between 950 and 1050° C. for a period of between 100 and 800 hours.

The process may also comprise a step (d) of separating the densified preforms obtained at the end of the chemical vapour infiltration process.

As described above, this step can be carried out by mechanical cutting or high-temperature heat treatment.

Such a step (d) can be carried out by heat treatment at a temperature greater than or equal to 2000° C. for more than 60 minutes.

Preferably, this heat treatment can take place even after a step (d) carried out by mechanical cutting.

Finally, step (e) involves machining the faces of the densified parts. Machining is typically carried out in order to rectify the upper and lower faces of densified parts.

For example, such a step (e) can be carried out by grinding the face of the preform 200.

The machining (e) may aim to remove a thickness of the preform face of between 2.0 and 5.0 mm.

The composite material parts obtained as a result of the process just described may be carbon/carbon composite material parts, for example friction parts or even brake discs.

1. (canceled)

2. (canceled)

3. (canceled)

4. (canceled)

5. (canceled)

6. (canceled)

7. (canceled)

8. (canceled)

9. A process for manufacturing an annular fibrous preform extending between an inner edge and an outer edge, said preform comprising at least one through-groove on at least one face, said process comprising:
hardening the annular fibrous preform; then
carving at least one through-groove on at least one face of the hardened preform.

10. The manufacturing process according to claim 9, wherein the hardening comprises:
saturating the annular fibrous preform with moisture; then
hardening the preform by lowering the temperature below 0° C.

11. A process for manufacturing a composite material part comprising:
manufacturing a plurality of annular fibrous preforms in accordance with the process for manufacturing an annular fibrous preform according to claim 9;
densifying, by a directed-flow chemical vapour infiltration process, at least one stack of annular fibrous preforms of said plurality of annular fibrous preforms;
separating the densified preforms obtained at the end of the directed-flow chemical vapour infiltration process; then
final machining of the faces of the densified fibrous preforms.

12. The process for manufacturing a composite material part according to claim 11, wherein the stack of annular fibrous preforms comprises annular fibrous preforms in direct contact with one another.

13. The processes according to claim 11, wherein said separating the densified preforms is a heat treatment step carried out at a temperature greater than or equal to 1600°C.

14. The process according to claim 11, wherein the composite material part comprises carbon fibres and a carbon matrix.

15. The manufacturing process according to claim 9, wherein the at least one through-groove has a constant width from the inner edge to the outer edge.

16. The manufacturing process according to claim 9, wherein the annular fibrous preform comprises a plurality of through-grooves angularly distributed over an entire face of the preform.

17. The manufacturing process according to claim 9, wherein at least one through-groove is present on each of the faces of the fibrous preform.

18. The manufacturing process according to claim 9, wherein the preform is a brake disc preform.

19. The manufacturing process according to claim 17, wherein the one or more surfaces comprising grooves are intended to form the one or more outer faces of said friction part.

20. The manufacturing process according to claim 9, wherein a smallest thickness of the preform is greater than or equal to 75% of a largest thickness of the preform.
